(19) United States
(12) Patent Application Publication
(10) Pub. No.: US 2024/0057638 A1
(43) Pub. Date: Feb. 22, 2024

(54) COMPOSITIONS FOR REDUCING METHANE EMISSION, METHODS FOR IMPROVING THE METABOLIC EFFICIENCY OF RUMINANT ANIMALS AND METHANOGENESIS INHIBITOR ADMINISTRATION

(71) Applicant: MOOTRAL INNOVATIONS LIMITED, ABERTILLERY, BLAENAU, GWENT (GB)

(72) Inventors: Peter Francis Fennessy, Dunedin (NZ); Daniel Wilhelm NEEF, Abertillery Blaenau Gwent (GB)

(73) Assignee: MOOTRAL INNOVATIONS LIMITED, ABERTILLERY, BLAENAU, GWENT (GB)

(21) Appl. No.: 18/268,263

(22) PCT Filed: Dec. 21, 2021
(86) PCT No.: PCT/GB2021/053388

§ 371 Date: Jun. 19, 2023

(30) Foreign Application Priority Data
Dec. 21, 2020 (NZ) 771419
Dec. 21, 2020 (NZ) 771420

(51) Int. Cl. A23K 20/105; A23K 50/10; A23K 20/111; A23K 20/121

(52) U.S. Cl. CPC A23K 20/105; A23K 50/10; A23K 20/111; A23K 20/121

(57) ABSTRACT

Compositions for reducing methane emission and/or inhibiting one or more methanogens are provided. The compositions comprise an organohalogen compound and an organo sulfur compound, preferably bromoform and allicin. The compositions may further comprise a polyphenol compound. An animal feed comprising the composition is also described.

### FIELD OF THE INVENTION

The present invention relates to compositions for reducing methane emission and/or for inhibiting one or more methane producing organism (i.e., methanogens). The present invention also relates methods for improving the metabolic efficiency of ruminant animals and methods for administration of methanogenesis inhibitors to ruminant animals, particularly agricultural ruminant animals.

### BACKGROUND OF THE INVENTION

Ruminant animals consume feeds containing carbon and nitrogen, which are converted into various materials including carbon-rich lipids, fats, fatty acids, and carbohydrates and nitrogen-rich proteins, nucleic acids, amino acids, and nucleotides.

Feeds converted into these materials contribute to animal growth and are major constituents of various valuable animal products.

However, ruminant animals, such as cattle, sheep and goats, are inefficient users of carbon and nitrogen. Ruminant methane production from carbon represents a loss of energy, from 2 to 12% of gross energy intake from feed.

Additionally, ruminant animals may excrete more than 50% of their nitrogen from feed, which is predominantly in the form of urinary and fecal nitrogen.

The loss of carbon and nitrogen from ruminant animals is both lost as valuable animal growth and has significant environmental impacts including contributing the potent greenhouse gases methane and nitrous oxide into the atmosphere and to nitrogen leaching in soils. Feed supplements administered to ruminant animals to improve animal growth, and to reduce carbon and nitrogen emissions into the environment, are costly and difficult to administer in an optimal and economic way.

One of the known methods of reducing methane production in ruminants is by using seaweed. However, feeding high amounts of seaweed to animals can have potential risk factors. One of the risk factors is reduction in feed intake and performance. Seaweed fed at higher levels in the diet has led to a reduced dry matter intake in beef (Roque et al., 2021) and in dairy cows (Roque et al., 2019, Stefenoni et al., 2021, Muizelaar et al., 2021). It was observed that cows regularly refused seaweed or selected against it when mixed with their fresh feed, indicating a poor palatability of seaweed (Muizelaar et al., 2021). A lower feed intake may also lead to lower performance as shown by reduced milk yield when cows are fed high dosage levels of seaweed (Roque et al., 2019, Stefenoni et al., 2021, Muizelaar et al., 2021). Seaweed is also known to contain high iodine levels (Makkar et al., 2016) and its transfer to livestock products has been studied. Feeding seaweed (Asparagopsis taxiformis) at 0.25% and 0.5% inclusion level in the diet to beef cattle resulted in a daily intake of iodine of 106 to 225 mg/day of iodine (Roque et al., 2021). This exceeds the recommended daily iodine intake levels of around 5 mg/day based on 0.5 mg/kg DMI (NRC, 2006) and 10 kg DM intake in this study. The transfer of iodine in milk is of a larger concern. Feeding Asparagopsis taxiformis at 0.5% in the diet increased iodine level 5 times to 3 mg/L according to Lean et al. (2021).

There is clearly a need to develop improved compositions for reducing methane emissions, particularly wherein the above-mentioned risk factors are reduced and/or wherein the compositions have improved palatability as compared with seaweed.

There is also clearly a need to improve metabolic efficiency of ruminant animals in order to reduce methane emissions and nitrogen excretions into the environment, and to improve animal growth levels and increase the amounts of valuable animal products.

The present invention addresses this need by providing feed supplements that improve the metabolic efficiency of ruminant animals. The feed supplements reduce the emission of methane and the excretion of nitrogen into the environment and converts the energy that would be otherwise be converted to emitted methane and otherwise excreted nitrogen into valuable animal products and hence, improving the metabolic efficiency of ruminant animals.

There is clearly a need to improve the administration of feed supplements to ruminant animals to improve animal growth, and to reduce carbon and nitrogen losses into the environment.

The present invention addresses this need by providing compositions and methanogenesis inhibitor feed supplement administration that optimally and economically reduces the emission of methane and the excretion of nitrogen and converts the energy that would be otherwise be converted to emitted methane and otherwise excreted nitrogen into valuable animal products.

### STATEMENT OF INVENTION

According to the present invention, in a first aspect, there is provided a composition for reducing methane emission comprising an organohalogen compound and an organosulfur compound.

In some embodiments, the organohalogen compound is an organobromine compound. In preferred embodiments, the organohalogen compound is bromoform (CHBr3).

In some embodiments, the organosulfur compound is from the Allium species of plants. In some embodiments, the organosulfur compound is selected from allicin (C6H10S2O); diallyl sulfide (C6H10S); diallyl disulfide (C6H10S2); and allyl mercaptan (C3H6S). In preferred embodiments, the organosulfur compound is allicin.

In some embodiments, the ratio of organohalogen compound to organosulfur compound is from 1:10 to 1:3500, more preferably from 1:1000 to 1:2500.

In some embodiments, the composition further comprises a polyphenol compound. In some embodiments, the polyphenol compound comprises or is a bioflavonoid. In some embodiments, the polyphenol compound comprises naringin, neohesperidin or a combination thereof.

In some embodiments, the composition is used for inhibiting one or more methanogens. In some embodiments, the composition is used for improving the metabolic efficiency of an animal, more particularly a ruminant animal, for example, a cattle, goat or sheep.

The present inventors found that the compositions of the present invention showed a high % inhibition of methanogen when an organohalogen compound (e.g., bromoform) was combined with an organosulfur compound (e.g., allicin).

In particular, it was shown that the organohalogen and organosulfur compound can act synergistically to reduce methane production. The synergistic combination delivers an effect that is greater than the sum of individual components. The present inventors additionally found that the compositions comprising an organohalogen compound (e.g., bromoform) and a powder mixture comprising organosulfur and polyphenol compounds (e.g., NXRH214 powder), also led to efficient inhibition of methanogens.

Also according to the present invention, in a second aspect, is an animal feed comprising the composition of the present invention or as otherwise disclosed herein.

Also according to the present invention, in a third aspect, is the use of the composition of the invention or the animal feed of the invention, for reducing methane emission and/or for inhibiting methanogens and/or improving the metabolic efficiency of an animal

Also according to the present invention, in a fourth aspect, is a method of reducing methane emission, the method comprising administering the composition or animal feed of the present invention to an animal, more particularly a ruminant animal. In some examples, the ruminant animal is a cattle, goat or sheep.

Also according to the present invention, in a fifth aspect, is a method of inhibiting one or more methanogens, the method comprising administering the composition or animal feed of the invention to an animal, more particularly a ruminant animal. In some examples, the ruminant animal is a cattle, goat or sheep.

Also according to the present invention, in a sixth aspect, is a method of improving the metabolic efficiency of an animal, the method comprising administering the composition or animal feed of the invention to an animal, more particularly a ruminant animal. In some examples, the ruminant animal is a cattle, goat or sheep.

Also disclosed herein is a composition for inhibiting one or more methanogens, said composition comprising an organohalogen compound and an organosulfur compound. The organohalogen compound and organosulfur compound are as otherwise described herein.

Also disclosed herein is a composition for improving the metabolic efficiency of an animal, said composition comprising an organohalogen compound and an organosulfur compound. The organohalogen compound and organosulfur compound are as otherwise described herein.

Also disclosed herein is a method of reducing excreted nitrogen and/or reducing emitted methane and/or increasing nitrogen-rich and carbon rich materials in a ruminant animal comprising the step of administering to said ruminant animal an effective amount of at least one type of methanogenesis inhibitor. In one embodiment, the method comprises administering to said ruminant animal any composition as disclosed herein.

In one embodiment, the methanogensis inhibitor is selected from the group comprising: organohalogen compounds; organohalogen-rich marine macroalgae; Organosulfur compounds; organosulfur-rich plants; polyphenol compounds; and polyphenol-rich plants.

In one embodiment, the organohalogen compound is selected from the group comprising: CH3Cl; CH3Br; CH3I; CH2Cl2; CH2Br2; CH2I2; CHCl3; CHBr3; CHI3; CCl4; CBr4; CH2CIBr; CH2ClI; CH2BrI; CHBr2Cl; CHBrI2; CHBrClI; CHBr2I; CHBrCl2; CH3CH2Br; CH3CH2I; CH3CH2CH2I; CH3(CH2)3I; CH3(CH2)4Br; CH3(CH2)4I; (CH3)2CHI; CH3CH2CH(CH3)I; (CH3)2CHCH2I; BrCH2CH2Br; ClCH═CCl2; and CH3CH2CH2CH2I.

In one embodiment, the organohalogen-rich marine macroalgae is selected from the group comprising: Asparagopsis armata; Asparagopsis taxiformis; Dictyota species; Oedogonium species; Ulva species; and Cladophora patentiramea.

In one embodiment the organosulfur compound is selected from the group comprising: organosulfur secondary metabolites; allicin (C6H10S2O); diallyl sulfide (C6H10S); diallyl disulfide (C6H10S2); and allyl mercaptan (C3H6S).

In one embodiment the organosulfur-rich plant is an Allium species selected from the group comprising: Allium sativum; Allium ampeloprasum; and Allium cepa.

In one embodiment the polyphenol compound is selected from the group comprising: flavonoids; bioflavonoids; non-bioflavonoid; The at least one polyphenol compound may, for example, comprise at least one bioflavonoid; anthoxanthins; flavones; flavonols; flavanones; flavanonols; flavans; anthocyanidins; isoflavans; neoflavan anthoxanthins; isoflavones; proanthocyanidins; phenolic acid; hydroxycinnamic acids; coumarins; stilbenoids; anthraquinones; lignans; lignins; tannins; polyphenolic proteins; catechin; rutin; acacetin; genistein; kaempferol; gallocatechin; catechin gallate; epicatechin; epigallocatechin; epicatechin gallate; quercetin; allocatechin; gallocathecin gallate; epicatechin; epigallocatechin; epicatechin gallate; epigallocathecin gallate; kaempferol; quercetin; naringin; neohesperidin; eriocitrin; isonaringin; naringenin; hesperidin; roifolin; diosmin; didymin; hesperetin; poncirin; epicatechin; gallocatechin; epigallocatechin; coumaric acid; cinnamic acid; gallic acid; ellagic acid; protocathechuic acid; chlorogenic acid; caffeic acid; ferullic acid; punicalagin; and punicalin

In one embodiment the polyphenol-rich plant is selected from the group comprising: Allium species; Brassica species; Camelia species; Capsicum species; Citrus species; Citrus aurantium; Cucumis species; Malus species; Musa species; Phaseolus species; Prunus species; Punica species; Pyrus species; Solanum species; and Vaccinium species.

In another aspect the present invention provides a method for reducing excreted nitrogen and emitted carbon and increasing valuable nitrogen-rich and carbon-rich materials in a ruminant animal, said method comprising the step of administering to said animal a feed supplement described herein or a feed described herein.

Herein is also disclosed, is a method of reducing excreted nitrogen and/or reducing emitted methane and/or increasing nitrogen-rich and carbon rich materials in a ruminant animal comprising the stepwise administering to said ruminant animal an effective amount of at least one type of methanogenesis inhibitor. In one embodiment, the method comprises administering to said ruminant animal the composition as disclosed herein.

In one embodiment the stepwise administration has at least one dose of methanogenesis inhibitor that is a percentage of weight of said ruminant animal selected from the group comprising: 0.1%; 0.2%; 0.3%; 0.4%; 0.5%; 0.6%; 0.7%; 0.8%; 0.9%; 1.0%; 1.1%; 1.2%; 1.3%; 1.4%; 1.5%; 2.0%; 2.5%; 3.0%; 3.5%; 4.0%; 4.5%; 5.0%; and 10%.

In one embodiment the stepwise administration has at least one dose of methanogenesis inhibitor that is a percentage of weight of feed of said ruminant animal selected from the group comprising: 0.1%; 0.2%; 0.3%; 0.4%; 0.5%; 0.6%; 0.7%; 0.8%; 0.9%; 1.0%; 1.1%; 1.2%; 1.3%; 1.4%; 1.5%; 2.0%; 2.5%; 3.0%; 3.5%; 4.0%; 4.5%; 5.0%; and 10%.

In one embodiment the stepwise administration has at least one interval between consecutive doses selected from the group comprising:1 minute; 1 hour; 1 day; 2 days; 3 days; 4 days ; 5 days; 6 days; 7 days; 10 days; 2 weeks; 3 weeks 4 weeks; 6 weeks; 2 months; 3 months; 4 months; 6 months; 9 months; and 12 months.

### BRIEF DESCRIPTION OF FIGURES

FIGS. 1 and 2 shows the % methane inhibition of various compositions of the present invention after incubation with an Methanococcus maripaludis culture.

### DETAILED DESCRIPTION OF THE INVENTION

According to the present invention there is provided a composition for reducing methane emission comprising an organohalogen compound and an organosulfur compound. The composition may also be used for inhibiting one or more methanogens. Any “composition” as referred to herein may also be referred to as an “animal feed supplement”.

In some embodiments, the one or methanogens have the genus Methanobacterium, Methanosarcina, Methanobrevibacter, Methanosarcina, Methanoculleus, Methanosphaera, Methanocorpusculum, Methanofollis, Methanogenium, Methanomicrobium, Methanopyrus, Methanoregula, Methanasaeta, Methanthermobacter or Methanococcus. In some embodiments, the one or more methanogens are selected from Methanobacterium formicicum, Methanobacterium bryantii, Methanobrevibacter ruminantium, Methanobrevibacter millerae, Methanobrevibacter olleyae, Methanomicrobium mobile, Methanoculleus olentangyi, Methanosarcina barkeri, Methanobrevibacter boviskoreani, Methanobacterium beijingense, Methanoculleus marisnigri, Methanoculleus bourgensis, Methanosarcina mazei, Methanobrevibacter gottschalkii, Methanobrevibacter thaueri, Methanobrevibacter smithii, Methanosphaera stadtmanae, Methanobrevibacter woesei, Methanobrevibacter wolinii. In some examples, the one or more methanogens is Methanococcus maripaludis.

Hereinafter, the invention shall be described according to preferred embodiments of the present invention and by referring to the accompanying description. However, it is to be understood that limiting the description to the preferred embodiments of the invention is merely to facilitate discussion of the present invention and it is envisioned that those skilled in the art may devise various modifications without departing from the scope of the appended claims.

Organohalogen Compound

The composition of the present invention comprises an organohalogen compound (i.e., at least one organohalogen compound).

Organohalogen compounds are organic compounds that contain a halogen. In some embodiments, the organohalogen compounds are C1-C6 alkyl halogen compounds. In some embodiments, the organohalogen compound comprises chlorine, bromine, iodine, or a combination thereof. In some embodiments, the organohalogen compound includes CH3Cl; CH3Br; CH3I; CH2Cl2; CH2Br2; CH2I2; CHCl3; CHBr3; CHI3; CCl4; CBr4; CH2CIBr; CH2ClI; CH2BrI; CHBr2Cl; CHBrI2; CHBrClI; CHBr2I; CHBrCl2; CH3CH2Br; CH3CH2I; CH3CH2CH2I; CH3(CH2)3I; CH3(CH2)4Br; CH3(CH2)4I; (CH3)2CHI; CH3CH2CH(CH3)I; (CH3)2CHCH2I; BrCH2CH2Br; ClCH═CCl2; and CH3CH2CH2CH2I. In some embodiments, the organohalogen compound is a trihalomethane. In some embodiments, the organohalogen compound is an organobromine compound, more preferably wherein the organohalogen compound is bromoform (CHBr3).

Biological sources of organohalogen compounds are organohalogen-rich marine macroalgae. For example, organohalogen-rich marine macroalgae includes at least one species of marine macroalgae selected from the group consisting of: Asparagopsis armata; Asparagopsis taxiformis; Dictyota species; Oedogonium species; Ulva species; and Cladophora patentiramea. Thus, in some embodiments, the organohalogen compound derives from an organohalogen-rich marine microalgae, for example, selected from the group consisting of: Asparagopsis armata; Asparagopsis taxiformis; Dictyota species; Oedogonium species; Ulva species; and Cladophora patentiramea.

In other embodiments, the organohalogen compounds are produced by bacteria, fungi and cyanobacteria. For example, the bacteria includes one species of bacteria selected from the group consisting of: Streptomyces sp. and Zobellia galactanivorans. For example, the fungi includes one species of fungi selected from the group consisting of: Pyricularia oryzae, Curvularia inaequalis, Pyrenophora tritici-repentis and Embellisia didymospora. For example, the cyanobacteria includes one species of cyanobacteria selected from the group consisting of: Trichodesmium erythraeum, Synechococcus sp. and Acaryochloris marina.

In other embodiments, the organohalogen is synthetic, i.e., the organohalogen is chemically synthesized. In other embodiments, the organohalogen is produced by a recombinant yeast.

In some embodiments, the concentration of organohalogen compound in the composition is greater than 100 nM, or greater than 110 nM, or greater than 120 nM, or greater than 130 nM, or greater than 140 nM, or greater than 150 nM. In some embodiments, the concentration of organohalogen compound in the composition is less than 10000 nM or less than 1000 nM or less than 500 nM or less than 200 nM, or less than 175 nM, or less than 160 nM, or less than 150 nM, or less than 140 nM, or less than 130 nM. In some embodiments, the concentration of organohalogen compound in the composition is between 100 nM and 10000 nM, is between 100 nM and 1000 nM, is between 100 nM and 500 nM, is between 100 nM and 300 nM, is between 100 nM and 200 nM, or between 110 nM and 175 nM. In some examples, the organohalogen compound is an organobromine compound, preferably bromoform.

Organosulfur Compound

The composition of the present invention comprises an organosulfur compound (i.e., at least one organosulfur compound).

Organosulfur compounds are organic compounds that contain sulfur. In certain embodiments, each organosulfur compound may independently be selected from thioethers, thioesters, thioacetals, thiols, disulfides, polysulfides, sulfoxides, sulfones, thiosulfinates, sulfimides, sulfoximides, sulfonediimines, thioketones, thioaldehydes, sulfines, sulfenes, thiocarboxylic acids (including dithiocarboxyklic acids), sulfonic acids, sulfinic acids, sulfenic acids, sulfonic esters, sulfinic esters, sulfenic esters, sulfonic amides, sulfinic amides, sulfenic amides, sulfonium compounds, oxosulfonium compounds, sulfonium ylides, oxosulfonium ylides, thiocarbonyl ylides, sulfuranes and persulfuranes. In certain embodiments, each organosulfur compound is independently selected from thioesters, sulfoxides, thioethers, disulfides, polysulfides (including trisulfides) and thiols. In certain embodiments, each organosulfur compound is independently selected from thioesters, sulfoxides, thioethers, disulfides and polysulfides (including trisulfides). In certain embodiments, each organosulfur compound is independently selected from disulfides and polysulfides (including trisulfides). In certain embodiments, each organosulfur compound is a disulfide.

In some embodiments, the organosulfur compound is from the Allium species of plants. In some embodiments, the organosulfur compound is a disulfide compound, and more specifically a diallyl disulfide compound.

In certain embodiments, each organosulfur compound is independently selected from allicin, allicin, allylpropyl disulfide, diallyl trisulfide, s-allylcysteine, vinyldithiines (3-vinyl-4H-1,2-dithiin and 2-vinyl-4H-1,3-dithiin) and diallyl disulphide.

In some embodiments, the organosulfur compound is selected from allicin (C6H10S2O); diallyl sulfide (C6H10S); diallyl disulfide (C6H10S2); and allyl mercaptan (C3H6S). In certain embodiments, the at least one organosulfur compound is or includes allicin.

Allicin is an organosulfur compound having the chemical formula C6H10OS2 and structure shown below.

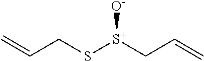

The organosulfur compound such as allicin may, for example, be obtained from garlic or another Allium species. For example, the organosulfur compound (e.g. allicin) may be obtained from an extract of an Allium species such as garlic (Allium sativum). The term extract encompasses aqueous extracts, non-aqueous extracts, alcoholic extracts, concentrates, oils, macerations, powders, granules and combinations of two or more thereof. For example, the organosulfur compound (e.g. allicin) may be obtained from raw garlic, dried garlic or a combination thereof. The organosulfur compound (e.g. allicin) may, for example, be derived from any of the subspecies and varieties of Allium that are currently known or are later discovered, such as garlic (Allium sativum), Allium ursinum, Allium fistulosum, Allium cepa and Allium tricoccum. For example, the organosulfur compound (e.g. allicin) may independently be derived from garlic of the subspecies ophioscorodon (hard neck garlic) and sativum (soft neck garlic). For example, the organosulfur compound (e.g. allicin) may independently be derived from porcelain garlics, rocambole garlics, purple stripe garlics, marbled purple stripe garlics, glazed purple stripe garlics, artichoke garlics, silverskin garlics, asiatic garlics, turban garlics and Creole garlics. In particular, the organosulfur compound (e.g. allicin) may be obtained from Allium sativum.

The Allium from which the organosulfur compound (e.g. allicin) may be derived may, for example, have been treated or processed. For example, the Allium may be “aged” or “black” (e.g. aged or black garlic), obtained by storing the Allium in controlled conditions and heated under specific temperature, humidity and solvents, for example over several days or weeks, to cause the cloves to darken in colour after undergoing Maillard or browning reaction. For example, the Allium may be “dried” or “dehydrated”, obtained by heating the fresh or non-aged garlic to a temperature of between 30° C. and 120° C. and achieving a moisture content of about 3 to 10%, with or without transforming or converting its constituents into different compounds. For example, the Allium may be “fresh” or “non-aged” (e.g. fresh or non-aged garlic), obtained without undergoing special treatment or processing intentionally to transform or convert its constituents into different compounds. The fresh or non-aged Allium may, for example, have been treated or processed to remove the odour (deodourised) (e.g. deodourised garlic extract). Generally, an encapsulation or coating process can be applied to mask or reduce the odour. Alternatively or additionally, taste-masking ingredients such as green tea, parsley, basil, spinach etc. can be added to mask or reduce the odour in a composition.

The organosulfur compound (e.g. allicin) may or may not be isolated and/or purified before incorporation into the compositions described herein. As such, in certain embodiments the compositions described herein may comprise raw garlic, dried garlic and/or garlic extracts. In other embodiments, the organosulfur compound (e.g. allicin) is chemically synthesized. In certain embodiments, allicin may be obtained by treating a natural source of allinase to release allinase, contacting the treated source of allinase with alliin, whereby alliin is enzymatically converted to allicin and optionally extracting the allicin. A suitable method is further described, for example, in WO 03/004668, the contents of which are incorporated herein by reference.

In other embodiments, organosulfur compound, e.g., allicin, may be synthetic, i.e., chemically synthesized.

In some embodiments, the concentration of organosulfur compound in the composition is greater than 10 μM, or greater than 100 μM, or greater than 150 μM, or greater than 175 μM, or greater than 200 μM, or greater than 225 μM, or greater than 250 μM, or greater than 275 μM. In some embodiments, the concentration of organosulfur compound in the composition is less than 350 μM, or less than 325 μM, or less than 300 μM, or less than 275 μM, or less than 250 μM, or less than 225 μM. In some embodiments, the concentration of organosulfur compound in the composition is between 10 μM and 350 μM, is between 100 μM and 350 μM, is between 150 μM and 350 μM, and in some examples, between 200 and 300 μM.

Ratio of Organohalogen Compound to Organosulfur Compound

In some embodiments, the ratio of the organohalogen compound to the organosulfur compound in the composition is preferably between 1:10 to 1:3500. In some embodiments, the ratio of the organohalogen compound to the organosulfur compound in the composition is between 1:50 to 1:3500, or from 1:100 to 1:3500, or from 1:500 to 1:3500, or from 1:750 to 1:3500, or from 1:1000 to 1:3500, or from 1:1500 to 1:3500 or from 1:2000 to 1:3500. In some embodiments, the ratio of the organohalogen compound to the organosulfur compound in the composition is between 1:500 to 1:3000, or from 1:500 to 1:2750, or from 1:500 to 1:2500, or from 1:500 to 1:2000, or from 1:500 to 1:1500. In preferred embodiments, the ratio of the organohalogen to the organosulfur compound in the composition is from 1:750 to 1:3000, or from 1:1000 to 1:2500.

In some examples, the organohalogen is an organobromine compound, such as bromoform, and the organosulfur compound is a disulfide, such as allicin.

Polyphenol Compound

The composition of the present invention may further comprise a polyphenol compound (i.e., one or more polyphenol compound(s).

The term phenol refers to a chemical compound comprising a hydroxyl group (—OH) bonded directly to an aromatic hydrocarbon group. The term polyphenol compound refers to a compound comprising more than one phenol group. The polyphenol compound described herein may comprise bioflavonoids, non-bioflavonoid polyphenol compounds or a combination thereof. The at least one polyphenol compound may, for example, comprise at least one bioflavonoid.

The term bioflavonoid refers to a class of plant and fungus secondary metabolites and having the general structure of a 15-carbon skeleton consisting of two phenyl rings (A and B) and heterocyclic ring (C), sometimes abbreviated as C6-C3-C6. Bioflavonoids are therefore polyphenols. The term bioflavonoid includes anthoxanthins (including flavones and flavonols), flavanones, flavanonols, flavans and anthocyanidins. The term bioflavonoid also includes compounds having a flavone backbone (2-phenyl-1,4-benzopyrone), an isoflavan backbone (3-phenylchromen-4-one) or a neoflavan backbone (4-phenylcoumarine). The term non-bioflavonoid polyphenol compound refers to other classes of polyphenol compounds known in the field that do not fall under the definition of the term bioflavonoid as described herein. The term non-bioflavonoid polyphenol compound includes polyphenol compounds comprising 6 or more carbons, 7 or more carbons, 8 or more carbons, 9 or more carbons, 10 or more carbons, 13 or more carbons, 14 or more carbons, 16 or more carbons, 18 or more carbons or 30 or more carbons. The term non-bioflavonoid polyphenol compound includes but is not limited to polyphenol acids (a C6-C1 structure), stilbenoids (a C6-C2-C6 structure), anthraquinones (a C6-C2-C6 structure) and lignans (a (C6-C3)2 structure). In some embodiments, the non-bioflavonoid polyphenol compounds are plant polymers including but not limited to lignins, catechol melanins, flavolans, polyphenolic proteins and polyphenols. In certain embodiments, the one or more bioflavonoids is each independently selected from anthoxanthins (including flavones and flavonols), flavanones (including flavanone glycosides), flavanonols, flavans, isoflavones, anthocyanidins and proanthocyanidins. In certain embodiments, each of the one or more bioflavonoids is independently selected from anthoxanthins and flavanones (including flavanone glycosides). In certain embodiments, all bioflavonoids are anthoxanthins and/or flavanones. In certain embodiments, the one or more bioflavonoid(s) is/are independently a flavone or a flavanone. In certain embodiments, all bioflavonoids are flavones and/or flavanones. The flavones and flavanones may, for example, independently be flavone glycosides and flavanone glycosides respectively. In certain embodiments, the one or more bioflavonoid(s) is/are flavanones. In certain embodiments, all of the bioflavonoid(s) is/are flavanones. In certain embodiments, the one or more bioflavonoid(s) is/are flavanone glycosides. In certain embodiments, all of the bioflavonoid(s) is/are flavanone glycosides. The one or more bioflavonoid(s) may, for example, be selected from the group consisting of naringin, neohesperidin, eriocitrin, isonaringin, naringenin, hesperidin, roifolin, diosmin, didymin, hesperetin, poncirin, catechin, rutin, acacetin, genistein, kaempferol, quercetin, epicatechin, gallocatechin, epigallocatechin, catechin gallate, epicatechin gallate, epigallocatechin gallate and gallocatechin gallate. In certain embodiments, the one or more bioflavonoid(s) includes naringin and neohesperidin. In certain embodiments, the one or more bioflavonoid(s) is a combination of naringin and neohesperidin. In certain embodiments, the one or more bioflavonoid(s) includes one or more of catechin, rutin, acacetin, genistein, kaempferol, gallocatechin, catechin gallate, epicatechin, epigallocatechin, epicatechin gallate and quercetin. In certain embodiments, the one or more bioflavonoid(s) includes one or more of catechin, rutin, acacetin, genistein and kaempferol. In certain embodiments, the one or more bioflavonoid(s) is a combination of catechin, rutin, acacetin, genistein and kaempferol. In certain embodiments, the one or more bioflavonoid(s) includes one or more of gallocatechin, catechin gallate, epicatechin, epigallocatechin, epicatechin gallate, gallocathecin gallate, epigalloacathecin gallate, kaempferol and quercetin. In certain embodiments, the one or more bioflavonoid(s) includes one or more of gallocatechin, catechin gallate, epicatechin, epigallocatechin, epicatechin gallate, kaempferol and quercetin. In certain embodiments, the one or more bioflavonoid(s) is a combination of gallocatechin, catechin gallate, epicatechin, epigallocatechin, epicatechin gallate, gallocathecin gallate, epigallocathecin gallate, kaempferol and quercetin. In certain embodiments, the one or more bioflavonoid(s) is a combination of gallocatechin, catechin gallate, epicatechin, epigallocatechin, epicatechin gallate, kaempferol and quercetin.

In some embodiments, the polyphenol comprises one or more non-bioflavonoid polyphenol compounds. In some embodiments, the one or more non-bioflavonoid phenolic compounds is each independently selected from phenolic acids, stilbenoids, anthraquinones, lignans, lignins, tannins, polyphenolic proteins and polyphenols. In certain embodiments, each of the one or more non-bioflavonoid polyphenol compounds is independently selected from tannins and polyphenols. In certain embodiments, all non-bioflavonoid polyphenol compounds are tannins and/or polyphenols.

The compositions described herein comprise one or more polyphenol compounds. For example, the compositions may comprise two or more polyphenol compounds or three or more polyphenol compounds or four or more polyphenol compounds or five or more or six or more or seven or more or eight or more or nine or more or ten or more polyphenol compounds. For example, the compositions may comprise one, two, three, four or five polyphenol compounds. The compositions described herein comprise one or more bioflavonoids. For example, the compositions may comprise two or more bioflavonoids or three or more bioflavonoids or four or more bioflavonoids or five or more or six or more or seven or more or eight or more or nine or more or ten or more bioflavonoids. For example, the compositions may comprise one, two, three, four or five bioflavonoids. For example, the compositions may comprise two bioflavonoids that may be naringin and neohesperidin. In another example, the compositions may comprise five bioflavonoids that may be catechin, rutin, acacetin, genistein and kaempferol. In alternative embodiments, the compositions may comprise seven bioflavonoids that may be gallocatechin, catechin gallate, epicatechin, epigallocatechin, epicatechin gallate, kaempferol and quercetin. In alternative embodiments, the compositions may comprise nine bioflavonoids that may be gallocatechin, catechin gallate, epicatechin, epigallocatechin, epicatechin gallate, gallocathecin gallate, epigallocathecin gallate, kaempferol and quercetin.

The one or more polyphenol compounds, for example the one or more bioflavonoids, may, for example, be obtained from a part of a plant (e.g., fruit or vegetable). For example, flavonols may be obtained from tomatoes, beans, almonds and/or turnips. For example, flavan-3-ols may be obtained from peaches, plums, strawberries and/or green tea. For example, flavones may be obtained from watermelon and/or peppers. For example, flavonones may be obtained from a Citrus species fruit. For example, anthocyanidins may be obtained from blueberries, bananas, strawberries, cranberries and/or plums. The one or more polyphenol compounds, for example the one or more bioflavonoids, may, for example, be obtained from a Citrus species fruit such as oranges, lemons, grapefruit, pomelo or limes. In particular, the one or more polyphenol compounds, for example the one or more bioflavonoids, may be obtained from oranges. The one or more polyphenol compounds, for example the one or more bioflavonoids, may, for example, be obtained from a Punica species fruit such as pomegranate (Punica granatum) or Socotra pomegranate (Punica protopunica). In particular, the one or more polyphenol compounds, for example the one or more bioflavonoids, may be obtained from pomegranates (Punica granatum).

The one or more polyphenol compounds, for example the one or more bioflavonoids, may, for example, be obtained from a part (e.g. leaves) of a Camellia species plant such as Camellia sinensis, Camellia taliensis, Camellia oleifera, Camellia assimilis, Camellia azalea, Camellia brevistyla, Camellia caudata, Camelllia chekiangoleosa, Camellia chrysantha, Camellia chrysanthoides, Camellia connata, Camellia crapnelliana, Camellia cuspidata, Camellia euphlebia, Camellia euryoides, Camellia flava, Camellia fleuryi, Camellia forrestii, Camellia fraterna, Camellia furfuracea, Camellia gilbertii, Camellia granthamiana, Camellis grijsii, Camellia hengchunensis, Camellia hiemalis, Camellia hongkongensis, Camellia irrawadiensis, Camellia japonica, Camellia kissii, Caemllia lutchuensis, Camellia miyagii, Camellia nitidissima, Camellis nokoensis, Camellia parviflora, Camellia pitardii, Camellia pleurocarpa, Camellia polyodonta, Camellia pubupetala, Camellia reticulata, Camellia rosiflora, Camellia rusticana, Camellia salicifolia, Camellia saluenensis, Camellia sasanqua, Camellia semiserrata, Camellis trasnokoensis, Camellia tsaii, Camellia tunghinensis, Camellia vietnamensis, Camellia x williamsii and Camellia yunnanensis. In particular, the one or more bioflavonoids may be obtained from Camellis sinensis (tea plant). Any subspecies or variety of Camellia sinensis may be used. The part of the Camellia sinensis (e.g., leaves) may be untreated or may be treated, for example, by steaming, withering, rolling, oxidation, fermentation and/or drying. The one or more polyphenol compounds, for example the one or more bioflavonoids, may, for example, be obtained from green tea (Camellia sinensis) leaves.

For example, the one or more polyphenol compounds, for example the one or more bioflavonoids, may be obtained from an extract of a Citrus species fruit, a Punica species fruit or a part of a Camellia species plant. The term extract encompasses aqueous extracts, non-aqueous extracts, alcoholic extracts, concentrates, oils, macerations, powders, granules and combinations of two or more thereof. For example, the one or more polyphenol compounds, for example the one or more bioflavonoids, may be obtained from dried Citrus fruit, dried Punica fruit or dried Camellia plant parts (e.g., leaves). For example, the one or more polyphenol compounds, for example the one or more bioflavonoids, may be obtained from raw Citrus fruit, raw Punica fruit or raw Camellia plant parts (e.g., leaves).

The one or more polyphenol compounds, for example the one or more bioflavonoids, may or may not be isolated and/or purified before incorporation into the compositions described herein. As such, in certain embodiments the compositions described herein may comprise raw Citrus fruit, dried Citrus fruit and/or Citrus fruit extracts, or raw Punica fruit, dried Punica fruit and/or Punica fruit extract, or raw Camellia plant, dried Camellia plant and/or Camellia plant extracts.

In other embodiments, the one or more polyphenol compounds, for example the one or more bioflavonoids, may each independently be chemically synthesized.

In certain embodiments, the compositions described herein comprise two polyphenol compounds, for example two bioflavonoids. The ratio of the first polyphenol compound to the second polyphenol compound, for example the first bioflavonoid to the second bioflavonoid, may, for example, range from about 0.5:5 to about 3:1. For example, the ratio of the first polyphenol compound to the second polyphenol compound, for example the first bioflavonoid to the second bioflavonoid, may range from about 0.5:5 to about 2.5: 1, or from about 0.5:5 to about 2:1, or from about 0.5:5 to about 1.5: 1, or from about 0.5:5 to about 1:1. For example, the ratio of the first polyphenol compound to the second polyphenol compound, for example the first bioflavonoid to the second bioflavonoid may range from about 1:5 to about 3:1, or from about 1.5:5 to about 3:1, or from about 2:5 to about 3:1, or from about 2.5:5 to about 3:1, or from about 3:5 to about 3:1, or from about 3.5:5 to about 3:1, or from about 4:5 to about 3:1, or from about 4.5:5 to about 3:1, or from about 5:5 to about 3:1. The ratio is preferably 2:1.

In certain embodiments, the compositions described herein comprise naringin and neohesperidin. In certain embodiments, the at least one polyphenol comprises a major portion of naringin, neohesperidin or a combination thereof, wherein a major portion refers to at least 50 wt. % of the total weight of the polyphenol compounds, or at least 60 wt. %, or at least 70 wt. %, or at least 80 wt. %, or at least 90 wt. %. The ratio of the naringin to neohesperidin may, for example, range from about 0.5:5 to about 3:1. For example, the ratio of naringin to neohesperidin may range from about 0.5:5 to about 2.5:1, or from about 0.5:5 to about 2:1, or from about 0.5:5 to about 1.5:1, or from about 0.5:5 to about 1:1. For example, the ratio of naringin to neohesperidin may range from about 1:5 to about 3:1, or from about 1.5:5 to about 3:1, or from about 2:5 to about 3:1, or from about 2.5:5 to about 3:1, or from about 3:5 to about 3:1, or from about 3.5:5 to about 3:1, or from about 4:5 to about 3:1, or from about 4.5:5 to about 3:1, or from about 5:5 to about 3:1. The ratio is preferably 2:1:

In certain embodiments, the ratio of total organosulfur compounds to total polyphenol compounds (for example the ratio of total organosulfur compounds to total bioflavonoids) ranges from about 16:1 to about 1:30. For example, the ratio of total organosulfur compounds to total polyphenol compounds (for example the ratio of total organosulfur compounds to total bioflavonoids) may range from about 15:1 to about 1:30, or from about 14:1 to about 1:30, or from about 13:1 to about 1:30, or from about 12:1 to about 1:30, or from about 10:1 to about 1:30, or from about 16:1 to about 1:16. For example, the ratio of total organosulfur compounds to total polyphenol compounds (for example the ratio of total organosulfur compounds to total bioflavonoids) may range from about 9:1 to about 1:25, or from about 8:1 to about 1:20, or from about 7:1 to about 1:15, or from about 6:1 to about 1:10, or from about 5:1 to about 1:8, or from about 4:1 to about 1:7, or from about 3:1 to about 1:6, or from about 2:1 to about 1:5, or from about 1:1 to about 1:4. For example, the ratio of total organosulfur compounds to total polyphenol compounds (for example the ratio of total organosulfur compounds to total bioflavonoids) may range from about 1:1 to about 1:3, or from about 2:1 to about 1:4. For example, the ratio of total organosulfur compounds to total polyphenol compounds (for example the ratio of total organosulfur compounds to total bioflavonoids) may be about 1:3.

In certain embodiments, the ratio of organosulfur compound to total polyphenol compounds (for example the ratio of total organosulfur compounds to total bioflavonoids) ranges from about 16:1 to about 1:30. For example, the ratio of organosulfur compound to total polyphenol compound (for example the ratio of total organosulfur compounds to total bioflavonoids) may range from about 15:1 to about 1:30, or from about 14:1 to about 1:30, or from about 13:1 to about 1:30, or from about 12:1 to about 1:30, or from about 10:1 to about 1:30, or from about 16:1 to about 1:16. For example, the ratio of organosulfur compound to total polyphenol compounds (for example the ratio of organosulfur compound to total bioflavonoids) may range from about 9:1 to about 1:25, or from about 8:1 to about 1:20, or from about 7:1 to about 1:15, or from about 6:1 to about 1:10, or from about 5:1 to about 1:8, or from about 4:1 to about 1:7, or from about 3:1 to about 1:6, or from about 2:1 to about 1:5, or from about 1:1 to about 1:4. For example, the ratio of organosulfur compound to total polyphenol compounds (for example the ratio of total organosulfur compounds to total bioflavonoids) may range from about 1:4 to about 1:8, or from about 1:1 to about 1:3, or from about 2:1 to about 1:4. For example, the ratio of organosulfur compound to total polyphenol compounds (for example the ratio of total organosulfur compounds to total bioflavonoids) may be about 1:6 or may be about 1:3. In preferred embodiments, the organosulfur compound is a disulfide compound. In preferred embodiments, the organosulfur compound is allicin and/or the polyphenol compounds are bioflavonoids comprising naringin and neohesperidin.

In some embodiments, the organosulfur compound and at least one polyphenol compound may be provided as a mixture. The mixture may be one as described in WO 2018/220340 A1 which is incorporated herein by reference. In the examples disclosed herein, the ratio of organosulfur compound to total polyphenol compounds in the mixture is 1:3 and the ratio of garlic powder to citrus extract is 93:7, which is referred to as “NXRH214” in the examples disclosed herein. In some examples disclosed herein, the ratio of organohalogen compound (e.g., bromoform) to a powder mixture comprising comprising organosulfur and polyphenol compound (e.g., NXRH214 powder) is from 1:100 to 1:100000, more preferably from 1:30000 to 1:100000, or from 1:35000 to 1:83000.

Other Additives

The composition may, for example, further comprise other animal feed supplements including, for example, vitamins, minerals, antibiotics, growth stimulants and combinations thereof. For example, the composition may comprise other biologically active animal feed supplements, for example suitable for reducing methane production/emissions and/or increasing availability of nutrients to the animal. The vitamin may be any one or more of vitamin A, vitamin D, vitamin E, vitamin K, thiamine, riboflavin, pyridoxine, cyanocobalamin, carotenoids (including beta-carotene, zeaxanthin, lutein and lycopene), niacin, folic acid, pantothenic acid, biotin, vitamin C, choline, inositol, and salts and derivatives thereof. The mineral may be any one or more of calcium, phosphorous, magnesium, iron, zinc, manganese, copper, cobalt, boron, iodine, sodium, potassium, molybdenum, selenium, chromium, fluorine and chloride. The animal feed composition may, for example, comprise from about 0.001 wt % to about 5 wt % of each additional animal feed supplement or from about 0.01 wt % to about 5 wt % or from about 0.1 wt % to about 5 wt % of each additional animal feed supplement.

The composition may, for example, comprise other components in addition to the organosulfur compound, organohalogen compound and optionally at least one polyphenol compound, such as, for example, flavourings, colourants, stabilizers, antioxidants, buffers, emulsifiers, dispersants, thickeners, solubilising agents, micronutrients (for example selenium), vitamins, other feed material (for example carbohydrates such as sugars and starches), soluble and insoluble fibres, cellulose, lignocellulose, cereal grains, cereal brans, grain middlings, grain husks, fruit and vegetable seeds, skins, peels, and the like.

Animal Feed

Also disclosed herein is an animal feed comprising the composition described herein. The animal feed may be solid (e.g. powder, granules, pellets), semi-solid (e.g. gel, ointment, cream, paste) or liquid (e.g. solutions, suspensions, emulsions). The animal feed may independently be solid, semi-solid (e.g. gel, ointment, cream, paste) or liquid (e.g. solutions, suspensions, emulsions). For example, the animal feed may both be liquid or both be semi-solid or both be solid. Alternatively, the animal feed and composition may each be a different physical state. For example, the animal feed may be solid or semi-solid and the composition may be liquid. The composition may, for example, be used to “top-dress” (added on top) a ruminant feedlot ration or may be used to blend into a total mixed ration. The composition may, for example, be added to the drinking water of the animal. In certain embodiments, the composition may be added to the drinking water of the animal immediately before ingestion, for example up to 1 hour before ingestion or up to 30 minutes before ingestion or up to 15 minutes before ingestion or up to 5 minutes before ingestion. The three main types of animal feed include roughages, concentrates and mixed feeds. In general, roughages contain a higher percentage of crude fibre and a lower percentage of digestible nutrients than concentrates. For example, roughages may be defined as containing equal to or greater than 20 wt % crude fibre and equal to or less than 60 wt % total digestible nutrients. Roughages may include, for example, dry roughages (e.g. hay, straw, artificially dehydrated forages containing at least 90 wt % dry matter), silages (formed from green forages such as grass, alfalfa, sorghum and corn and preserved in a silo at dry matter contents of 20 to 50%), and pastures (e.g. green growing pastures providing forage that has a high water content and generally less than 30% dry matter). The two basic types of roughages include grasses and legumes. Grasses are generally higher in fibre and dry matter than legumes. Legumes are generally higher in proteins, metabolizable energy, vitamins and minerals. Concentrates contain a relatively lower percentage of crude fibre and a higher percentage of digestible nutrients than roughages. For example, concentrates may be defined as containing less than 20 wt % crude fibre and greater than 60 wt % total digestible nutrients. Concentrates may include, for example, energy-rich grains and molasses. Corn, wheat, oats, barley and milo (sorghum grain) are energy-rich grains, containing about 70 to 80 wt % total digestible nutrients.

Mixed feeds are generally a mixture of roughages and concentrates to provide “complete” balanced rations and may be either high or low in energy, protein or fibre. The at least one organosulfur compound and at least one polyphenol compound (e.g. at least one bioflavonoid) may, for example, be combined with animal feed in various amounts depending on the total amount of organohalogen compound(s), organosulfur compound(s) and optionally polyphenol compound(s) (e.g. bioflavonoid(s)) that are intended to be administered to the animal.

The animal feed may, for example, comprise from about 0.0001 wt % to about 10 wt % of organosulfur compound (e.g., allicin), based on the total dry weight of the animal feed. The animal feed may, for example, comprise from about 0.3 wt % to about 10 wt % of organosulfur compound (e.g., allicin), based on the total dry weight of the animal feed. For example, the animal feed may comprise from about 0.001 wt % to about 9.5 wt %, or from about 0.005 wt % to about 9 wt %, or from about 0.01 wt % to about 8.5 wt %, or from about 0.05 wt % to about 8 wt %, or from about 0.1 wt % to about 7.5 wt %, or from about 0.9 wt % to about 7 wt %, or from about 1 wt % to about 6 wt %, or from about 1.5 wt % to about 5.5 wt %, or from about 2 wt % to about 5 wt %, or from about 2.5 wt % to about 4.5 wt %, or from about 3 wt % to about 4 wt % organosulfur compound (e.g., allicin) based on the total dry weight of the animal feed. For example, the animal feed may comprise from about 0.4 wt % to about 9.5 wt %, or from about 0.5 wt % to about 9 wt %, or from about 0.6 wt % to about 8.5 wt %, or from about 0.7 wt % to about 8 wt %, or from about 0.8 wt % to about 7.5 wt %, or from about 0.9 wt % to about 7 wt %, or from about 1 wt % to about 6 wt %, or from about 1.5 wt % to about 5.5 wt %, or from about 2 wt % to about 5 wt %, or from about 2.5 wt % to about 4.5 wt %, or from about 3 wt % to about 4 wt % organosulfur compound (e.g., allicin) based on the total dry weight of the animal feed . The concentration of total organosulfur compound (e.g., allicin) present in the animal feed supplements or animal feed compositions described herein is typically in excess of the concentration of each organohalogen compound. As indicated above, the ratio of organohalogen compound to organosulfur compound in the animal feed may be from about 1:10 to 1:3500, or from 1:100 to 1:3500, or more preferably from 1:1000 to 1:2500. Therefore, in some embodiments, the animal feed may comprise from about 0.00015 wt. % to about 0.01 wt. % of organosulfur compound (e.g., allicin) based on the total dry weight of the animal feed.

If present, the animal feed may, for example, comprise from about 0.0001 wt % to about 10 wt % total polyphenol compounds (e.g., total bioflavonoids), based on the total dry weight of the animal feed. The animal feed may, for example, comprise from about 0.1 wt % to about 10 wt % total polyphenol compounds (e.g., total bioflavonoids), based on the total dry weight of the animal feed. For example, the animal feed may comprise from about 0.001 wt % to about 10 wt %, or from about 0.005 wt % to about 10 wt %, or from about 0.01 wt % to about 9.5 wt %, or from about 0.05 wt % to about 9 wt %, or from about 0.1 wt % to about 8.5 wt %, or from about 0.7 wt % to about 8 wt %, or from about 0.8 wt % to about 7.5 wt %, or from about 0.9 wt % to about 7 wt %, or from about 1 wt % to about 6 wt %, or from about 1.5 wt % to about 5.5 wt %, or from about 2 wt % to about 5 wt %, or from about 2.5 wt % to about 4.5 wt %, or from about 3 wt % to about 4 wt % total polyphenol compounds (e.g., total bioflavonoids), based on the total dry weight of the animal feed. For example, the animal feed may comprise from about 0.2 wt % to about 10 wt %, or from about 0.3 wt % to about 10 wt %, or from about 0.4 wt % to about 9.5 wt %, or from about 0.5 wt % to about 9 wt %, or from about 0.6 wt % to about 8.5 wt %, or from about 0.7 wt % to about 8 wt %, or from about 0.8 wt % to about 7.5 wt %, or from about 0.9 wt % to about 7 wt %, or from about 1 wt % to about 6 wt %, or from about 1.5 wt % to about 5.5 wt %, or from about 2 wt % to about 5 wt %, or from about 2.5 wt % to about 4.5 wt %, or from about 3 wt % to about 4 wt % total polyphenol compounds (e.g. total bioflavonoids) based on the total dry weight of the animal feed. The concentration of total organosulfur compound (e.g., allicin) present in the animal feed supplements or animal feed compositions described herein may be in excess of the concentration of the total polyphenol compound(s).

Methods of the Disclosure

Disclosed herein is a method of reducing methane, for example, reducing methane production by an animal, the method comprising administering the composition or animal feed as described herein to an animal, more particularly a ruminant animal.

The composition and method described herein may, for example, reduce methane production and/or emissions by at least about 10% (compared to methane production and/or emission if the animal feed supplement was not consumed). For example, the animal feed supplement may reduce methane production and/or emissions by at least about 10%, or at least about 15%, or at least about 25%, or at least about 30%, or at least about 35%, or at least about 40% or at least about 45%, or at least about 50%, or at least about 60%, or at least about 70%, or at least about 80%. The animal feed supplement described herein may, for example, reduce methane production and/or emissions by up to 100%. For example, the animal feed supplement may reduce methane production and/or emissions by up to about 99%, or up to about 98%, or up to about 97%, or up to about 96%, or up to about 95%, or up to about 90%, or up to about 85%, or up to about 80%, or up to about 75%, or up to about 70%. This may, for example, be measured by the Hohenheim gas test or by using a manometer.

Also disclosed herein is a method of inhibiting one or more methanogens comprising administering the composition or animal feed as described herein to an animal, more particularly a ruminant animal. in some embodiments, the compositions and combinations disclosed herein can be used to reduce one or more methanogens selected from Methanobacterium formicicum, Methanobacterium bryantii, Methanobrevibacter ruminantium, Methanobrevibacter millerae, Methanobrevibacter olleyae, Methanomicrobium mobile, Methanoculleus olentangyi, Methanosarcina barkeri, Methanobrevibacter boviskoreani, Methanobacterium beijingense, Methanoculleus marisnigri, Methanoculleus bourgensis, Methanosarcina mazei, Methanobrevibacter gottschalkii, Methanobrevibacter thaueri, Methanobrevibacter smithii, Methanosphaera stadtmanae, Methanobrevibacter woesei, Methanobrevibacter wolinii.

Also disclosed herein is a method of improving the metabolic efficiency of an animal, the method comprising administering the composition or the animal feed of the invention to an animal. The improvement in metabolic efficiency may result in an increased yield of animal products, for example, one or more of meat, fat, wool (i.e., fibers) and milk. Thus, the present composition or method can improve the meat and/or fat and/or wool and/or milk production of an animal.

The composition, animal feed and methods described herein may, for example, increase milk and/or meat and/or wool production by at least about 20% (compared to milk and/or meat and/or fat and/or wool production if the composition or animal feed was not consumed). For example, the composition or animal feed may increase milk and/or meat and/or fat and/or wool production by at least about 25%, or at least about 30%, or at least about 35%, or at least about 40%, or at least about 45%, or at least about 50%. The composition or animal feed described herein may, for example, increase milk and/or meat and/or fat and/or wool production by up to 100%. For example, the composition or animal feed may increase milk and/or meat and/or fat and/or wool production by up to about 95%, or up to about 90%, or up to about 85%, or up to about 80%, or up to about 75%, or up to about 70%. This may be measured, for example, by volume of milk produced per day or by weight of animal or by weight of wool and/or fat and/or meat produced.

The composition and animal feed described herein may, for example, increase efficiency of milk and/or meat and/or wool production by at least about 20% (compared to the efficiency of milk and/or meat and/or fat and/or wool production if the composition or animal feed was not consumed). For example, the composition or animal feed described herein may increase efficiency of milk and/or meat and/or fat and/or wool production by at least about 25%, or at least about 30%, or at least about 35%, or at least about 40%, or at least about 45%, or at least about 50%. The composition or animal feed described herein may, for example, increase efficiency of milk and/or meat and/or fat and/or wool production by up to 100%. For example, the composition or animal feed described herein may increase efficiency of milk and/or meat and/or fat and/or wool production by up to about 95%, or up to about 90%, or up to about 85% or up to about 80%, or up to about 75% ,or up to about 70%. Efficiency relates to the degree to which a particular biological process (e.g. milk, meat, fat, wool production) takes place per unit of nutrition consumed. This may be measured, for example, by change in volume of milk produced per day or weight of animal or weight of wool or fat divided by the total nutrients consumed by the animal. The composition or animal feed described herein may, for example, increase nutrient availability by at least about 20% (compared to milk and/or meat and/or fat and/or wool production if the composition or animal feed was not consumed). For example, the composition or animal feed described herein may increase nutrient availability by at least about 25%, or at least about 30%, or at least about 35%, or at least about 40%, or at least about 45%, or at least about 50%. The composition or animal feed described herein may, for example, increase nutrient availability by up to 100%. For example, the composition or animal feed described herein may increase nutrient availability by up to about 95%, or up to about 90%, or up to about 85%, or up to about 80%, or up to about 75%, or up to about 70%. Nutrient availability refers to the amounts of nutrients that are available to the animal to be used for biological/metabolic functions.

In some embodiments, the ruminant animal is a cattle, goat, sheep, yak, deer or antelope. In some embodiments, the ruminant animal is a cattle, goat or sheep.

The composition or animal feed may be administered orally to the animal. In some embodiments, the composition or animal feed may be administered daily to the animal.

Improving the Metabolic Efficiency of Ruminant Animals

The present disclosure provides for feed supplement preparations, incorporating biologically or synthetically derived organohalogen, organosulfur and polyphenol compounds, which are suitable for oral administration to ruminant animals to improve their metabolic efficiency, for the reduction of emitted methane and the reduction of excreted nitrogen and for the increase of valuable animal products such as meat, fat, fibers and milk.

The present invention is based on the unexpected finding that certain organohalogen compounds, organosulfur compounds and polyphenol compounds, when administered to ruminant animals to reduce the emission of methane in said ruminant animals also improve the metabolic efficiency of said ruminant animals and also reduce the excretion of urinary nitrogen and increase the production of valuable animal products. Furthermore, when said organohalogen compounds, organosulfur compounds and polyphenol compounds are administered in certain combinations, there is a surprising enhancement in the reduction of both emitted methane and excreted nitrogen and a surprising enhancement in the increase in production of valuable animal products.

The inventor has recognized the unexpected and surprising improvements on metabolic efficiency from feed supplements that comprise certain combinations of organohalogen-rich marine macroalgae and organosulfur-rich plants and polyphenol-rich plants.

The combinations of organohalogen-rich marine macroalgae and organosulfur-rich plants and polyphenol-rich plants of the present invention when administered to ruminant animals reduce methanogenesis and reduce ruminant methane production. The reduction of methanogenesis occurs by different modes including: reducing methanogenic organisms by limiting their growth or killing them; reducing methanogenic processes, by limiting or stopping enzymes involved in methanogenesis.

Methanogens identified in cattle, sheep and goat include Methanobacterium formicicum, Methanobacterium bryantii, Methanobrevibacter ruminantium, Methanobrevibacter millerae, Methanobrevibacter olleyae, Methanomicrobium mobile, Methanoculleus olentangyi, Methanosarcina barkeri, Methanobrevibacter boviskoreani, Methanobacterium beijingense, Methanoculleus marisnigri, Methanoculleus bourgensis, Methanosarcina mazei, Methanobrevibacter gottschalkii, Methanobrevibacter thaueri, Methanobrevibacter smithii, Methanosphaera stadtmanae, Methanobrevibacter woesei, and Methanobrevibacter wolinii. Thus, in some embodiments, the compositions and combinations disclosed herein can be used to reduce one or more methanogens selected from Methanobacterium formicicum, Methanobacterium bryantii, Methanobrevibacter ruminantium, Methanobrevibacter millerae, Methanobrevibacter olleyae, Methanomicrobium mobile, Methanoculleus olentangyi, Methanosarcina barkeri, Methanobrevibacter boviskoreani, Methanobacterium beijingense, Methanoculleus marisnigri, Methanoculleus bourgensis, Methanosarcina mazei, Methanobrevibacter gottschalkii, Methanobrevibacter thaueri, Methanobrevibacter smithii, Methanosphaera stadtmanae, Methanobrevibacter woesei, and Methanobrevibacter wolinii.

The combinations of organohalogen-rich marine macroalgae and organosulfur-rich plants and polyphenol-rich plants of the present invention have unexpected and surprising enhancement in the reduction of methane emission and excreted urinary nitrogen, and in the increase of valuable animal products, which is likely due to the synergy between different modes of inhibition of methanogenesis including for example:

The organohalogen compounds from Asparagopsis species of marine macroalgae include organobromines, particularly bromoform (CHBr3, tribromomethane), which inhibits the efficiency of the methyltransferase enzyme by reacting with the reduced vitamin B12 cofactor required for the second to last step of methanogenesis and also competitively inhibits methane production by serving as terminal electron acceptors.

The organosulfur compounds from Allium species of plants include allicin and diallyl disulfide, which have antimethanogen activity due to the oxidative interaction with important thiol-containing enzymes and by inhibiting the enzyme HMG-CoA reductase.

The polyphenol compounds from Citrus species of plant include flavonoids neohesperidin and naringin, which have antimethanogen activity.

The inventor has recognized the unexpected and surprising improvements in metabolic efficiency due to the supplements of the present invention may also be due to additional health benefits that include for example: anthelmintic effects that cause a reduction in gastrointestinal parasites; antibacterial effects that cause a reduction of bacterial infections including for example mastitis; and the provision of supplementary trace mineral and vitamins present in combinations of organohalogen-rich marine macroalgae and organosulfur-rich plants and polyphenol-rich plants of the present invention when administered to ruminant animals.

The combinations of organohalogen-rich marine macroalgae and organosulfur-rich plants and polyphenol-rich plants of the present invention can be administered as feed supplements in certain combinations and certain ratios.

The combinations of organohalogen-rich marine macroalgae and organosulfur-rich plants and polyphenol-rich plants of the present invention can be administered as separate feed supplements or combined into mixed composition feed supplements.

Uses

The compositions or animal feed supplements described herein (including all embodiments and combinations of embodiments) may be used to reduce methane production and/or emission by animals, reduce nitrogen excretion by animals, increase availability of nutrients to animals and/or increase the valuable nitrogen-rich and carbon-rich animal products by animals.

In certain embodiments, the animal is a ruminant animal. Ruminant animals include, animals selected from the members of the Ruminantia and Tylopoda suborders and include domesticated ruminant animals: for example, cattle (e.g., cows), goats, sheep, buffalo, yaks, deer or antelope.

Specifically, compositions or the feed supplements of the present invention, when administered to ruminant animals in effective amounts, cause reduced ruminant animal methane production, which would otherwise be emitted into the atmosphere by exhaling the gas mainly through the mouth and nostrils, and represents a loss of energy, from 2 to 12% of gross energy intake from feed.

Methane is a greenhouse gas with a global warming potential 28 times that of carbon dioxide. Enteric methane is a by-product of ruminant digestion and is produced by a complex community of microorganisms including ciliate protozoa, bacteria, archaea and anaerobic fungi by the process called methanogenesis. Cattle produce about 7 and 9 times as much methane as sheep and goats, respectively. Enteric methane is produced mainly in the rumen (87%-90%) and, to a lesser extent (13%-10%), in the large intestine.

The compositions and feed supplements of the present invention cause the diversion of metabolic energy away from methane generation, and direct it into anabolic growth processes. Thus, the feed supplements cause gains in ruminant animal liveweight determined by: direct weighing of the animal mass; computer tomography (CT) scans to measure empty body mass (total mass less the gut contents); carcass mass, and composition analysis (lean muscle, fat, and major fat distributions; and changes in organs, including the liver).

An example of valuable nitrogen-rich and carbon-rich animal products are tissue-based commodities and includes for example: meat; offal; and leather.

Another example of valuable nitrogen-rich and carbon-rich animal products are secretion-based commodities and products of those commodities and includes for example: milk; whole milk; milk powder; cream; ice-cream; cheese; and yoghurt.

Another example of valuable nitrogen-rich and carbon-rich animal products are fiber-based commodities and includes for example: wool; horn; and antler.

The compositions and feed supplements of the present invention cause the unexpected and surprising improvements in metabolic efficiency which likely cause the reduction of excreted urinary nitrogen, which following urination is deposited in urine patches on pastures. When the excess excreted nitrogen in urine patches is greater than required for optimal pasture plant efficiency, excess nitrogen is lost via nitrate (NO3—) leaching, and ammonia (NH3), nitrous oxide (N2O) and nitrogen (N2) volatilization. Nitrous oxide is particularly damaging to the atmosphere as a greenhouse gas with a global warming potential 298 times that of carbon dioxide. Nitrogen loss to ground water can cause uncontrolled growth of aquatic biota thereby damaging ecosystems, causing toxic algal blooms, and the eutrophication of water bodies.

Methods of Manufacture

The compositions or animal feed supplements described herein may be made by combining one or more organohalogen compound(s) and one or more organosulfur compound(s) and one or more polyphenol compound(s).

Organohalogen compounds can be synthesized or extracted from a suitable biological source and used in a raw or processed format. For example organohalogen compounds includes: CH3Cl; CH3Br; CH3I; CH2Cl2; CH2Br2; CH2I2; CHCl3; CHBr3; CHI3; CCl4; CBr4; CH2CIBr; CH2ClI; CH2BrI; CHBr2Cl; CHBrI2; CHBrClI; CHBr2I; CHBrCl2; CH3CH2Br; CH3CH2I; CH3CH2CH2I; CH3(CH2)3I; CH3(CH2)4Br; CH3(CH2)4I; (CH3)2CHI; CH3CH2CH(CH3)I; (CH3)2CHCH2I; BrCH2CH2Br; ClCH═CCl2; and CH3CH2CH2CH2I.

Biological sources of organohalogen compounds are organohalogen-rich marine macroalgae. For example, organohalogen-rich marine macroalgae includes at least one species of marine macroalgae selected from the group consisting of: Asparagopsis armata; Asparagopsis taxiformis; Dictyota species; Oedogonium species; Ulva species; and Cladophora patentiramea.

Organosulfur compounds can be synthesized or extracted from a suitable biological source and used in a raw or processed format. Organosulfur compounds include: organosulfur secondary metabolite; allicin (C6H10S2O), diallyl sulfide (C6H10S), diallyl disulfide (C6H10S2) and allyl mercaptan (C3H6S).

Biological sources of organsulfur compounds are organosulfur-rich plants. For example, organosulfur-rich plants include: Allium species; A. sativum (garlic); A. ampeloprasum (leek); A. cepa (onion and shallot). The one or more organosulfur compounds may be obtained from one or more parts of a plant including for example: leaves; stem; bark; root; bulb; flower; fruit; and seed.

Polyphenol compounds can be synthesized or extracted from a suitable biological source and used in a raw or processed format. For example, polyphenol compounds includes bioflavonoids and phenolic compounds. The term phenolic compound refers to a class of chemical compounds comprising a hydroxyl group (—OH) bonded directly to an aromatic hydrocarbon group. The phenolic compound described herein may comprise bioflavonoids, non-bioflavonoid phenolic compounds or a combination thereof. The at least one polyphenol compound may, for example, comprise at least one bioflavonoid. The term bioflavonoid refers to a class ofplant and fungus secondary metabolites and having the general structure of a 15-carbon skeleton consisting of two phenyl rings (A and B) and heterocyclic ring (C), sometimes abbreviated as C6-C3-C6. The term bioflavonoid includes anthoxanthins (including flavones and flavonols), flavanones, flavanonols, flavans and anthocyanidins. The term bioflavonoid also includes compounds having a flavone backbone (2-phenyl-1,4-benzopyrone), an isoflavan backbone (3-phenylchromen-4-one) or a neoflavan backbone (4-phenylcoumarine). Thus the term polyphenol compounds includes, but is not limited to: anthoxanthins; flavanones (including flavanone glycosides); flavonols; flavanonols; flavans; isoflavones; anthocyanidins; proanthocyanidins; phenolic acid; hydroxycinnamic acids; coumarins; stilbenoids; anthraquinones; lignans; lignins; tannins; polyphenolic proteins; catechin; rutin; acacetin; genistein; kaempferol; gallocatechin; catechin gallate; epicatechin; epigallocatechin; epicatechin gallate; quercetin; allocatechin; gallocathecin gallate; epicatechin; epigallocatechin; epicatechin gallate; epigallocathecin gallate; kaempferol; quercetin; naringin; neohesperidin; eriocitrin; isonaringin; naringenin; hesperidin; roifolin; diosmin; didymin; hesperetin; poncirin; epicatechin; gallocatechin; epigallocatechin; coumaric acid; cinnamic acid; gallic acid; ellagic acid; protocathechuic acid; chlorogenic acid; caffeic acid; ferullic acid; punicalagin; punicalin.

Biological sources of polyphenol compounds are polyphenol-rich plants. For example, polyphenol-rich plants include: Allium species; Brassica species; Camelia species; Capsicum species; Citrus species; Cucumis species; Malus species; Musa species; Phaseolus species; Prunus species; Punica species; Pyrus species; Solanum species; Vaccinium species. The one or more polyphenol compounds may be obtained from one or more parts of a plant including for example: leaves; stem; bark; root; bulb; flower; fruit; and seed.

The compositions or animal feed supplements described herein may be made by combining one or more organohalogen-rich marine macroalgae and one or more organosulfur-rich plant(s) compound(s) and one or more polyphenol-rich plant(s).

The components are combined in suitable amounts to obtain a composition having the desired quantity of each component. Each component may be combined with one or more other components in any order and combination suitable to obtain the desired product. For example, each component may be combined by mixing or blending. For example, the one or more organohalogen compound(s) and one or more organosulfur compound(s) and one or more polyphenol compound(s) may be combined with an animal feed by placing the one or more organohalogen compound(s) and one or more organosulfur compound(s) and one or more polyphenol compound(s) on top of the animal feed (top-dressing).

The composition may be prepared in the dry solid form, for example, powder form, and subject to further processing step depending on the types of the formulation for the intended finished products. The methods may further comprise a forming step, wherein the mixture is moulded, pressed, spray dried or otherwise formed into a shape (e.g. bar, ball, pellet, clusters, tablet), preferably with dimensions and/or textures suitable for consumption by an animal of the types described herein. The methods may comprise housing the animal feed or animal feed supplement in a specific delivery device such as a syringe. The method may comprise forming animal feed supplement or animal feed into a bolus tablet that may be intended to stay in the stomach of the animal (e.g. rumen of the ruminant animal).

Methanogenesis Inhibitor Administration

Herein is also disclosed are methods of stepwise administration of methanogenesis inhibitor feed supplements, incorporating biologically derived organohalogen, and/or organosulfur compounds, and/or polyphenol compounds, which are suitable for oral administration to ruminant animals to improve their metabolic efficiency, for the reduction of emitted methane and the reduction of excreted nitrogen and for the increase of valuable animal products such as meat, fat, fibers and milk.

As used herein, the term “stepwise” means administering at least one dose of an effective amount of at least one methanogenesis inhibitor and optionally after some effective interval of time administering at least one consecutive dose of an effective amount of at least one methanogenesis inhibitor.

The present disclosure is based on the unexpected finding that said feed supplements when stepwise administered to said animals at both certain effective doses of amount and certain effective intervals of time provides a surprising economic benefit through improved metabolic efficiency, reduction of emitted methane and the reduction of excreted nitrogen and for the increase of valuable animal products such as meat, fat, fibers and milk.

The inhibition of methanogenesis occurs by different modes of action including for example: reducing methanogenic processes; by limiting or stopping enzymes involved in methanogenesis; or by reducing methanogenic organisms by limiting their growth or killing them.

Methanogenesis inhibitors includes for example: organohalogen compounds; CH3Cl; CH3Br; CH3I; CH2Cl2; CH2Br2; CH2I2; CHCl3; CHBr3; CHI3; CCl4; CBr4; CH2CIBr; CH2ClI; CH2BrI; CHBr2Cl; CHBrI2; CHBrClI; CHBr2I; CHBrCl2; CH3CH2Br; CH3CH2I; CH3CH2CH2I; CH3(CH2)3I; CH3(CH2)4Br; CH3(CH2)4I; (CH3)2CHI; CH3CH2CH(CH3)I; (CH3)2CHCH2I; BrCH2CH2Br; ClCH═CCl2; and CH3CH2CH2CH2I; organosulfur compounds; organosulfur secondary metabolite; allicin (C6H10S2O), diallyl sulfide (C6H10S), diallyl disulfide (C6H10S2); allyl mercaptan (C3H6S); polyphenol compounds; flavonoids; bioflavonoids; non-bioflavonoid; anthoxanthins; flavones; flavonols; flavanones; flavanonols; flavans; anthocyanidins; isoflavans; neoflavan anthoxanthins; isoflavones; proanthocyanidins; phenolic acid; hydroxycinnamic acids; coumarins; stilbenoids; anthraquinones; lignans; lignins; tannins; polyphenolic proteins; catechin; rutin; acacetin; genistein; kaempferol; gallocatechin; catechin gallate; epicatechin; epigallocatechin; epicatechin gallate; quercetin; allocatechin; gallocathecin gallate; epicatechin; epigallocatechin; epicatechin gallate; epigallocathecin gallate; kaempferol; quercetin; naringin; neohesperidin; eriocitrin; isonaringin; naringenin; hesperidin; roifolin; diosmin; didymin; hesperetin; poncirin; epicatechin; gallocatechin; epigallocatechin; coumaric acid; cinnamic acid; gallic acid; ellagic acid; protocathechuic acid; chlorogenic acid; caffeic acid; ferullic acid; punicalagin; and punicalin.

Biological sources of organohalogen compounds are organohalogen-rich marine macroalgae. For example, organohalogen-rich marine macroalgae includes at least one species of marine macroalgae selected from the group consisting of: Asparagopsis armata; Asparagopsis taxiformis; Dictyota species; Oedogonium species; Ulva species; and Cladophora patentiramea. The organohalogen compounds, organobromine compounds and bromoform disclosed herein may also be synthetic.

Biological sources of organosulfur compounds are organosulfur-rich plants. For example, organosulfur-rich plants include: Allium species; A. sativum (garlic); A. ampeloprasum (leek); A. cepa (onion and shallot). The one or more organosulfur compounds may be obtained from one or more parts of a plant including for example: leaves; stem; bark; root; bulb; flower; fruit; and seed. The organosulfur compounds disclosed herein may also be synthetic.

Biological sources of polyphenol compounds are polyphenol-rich plants. For example, polyphenol-rich plants include: Allium species; Brassica species; Camelia species; Capsicum species; Citrus species; Cucumis species; Malus species; Musa species; Phaseolus species; Prunus species; Punica species; Pyrus species; Solanum species; Vaccinium species. The one or more polyphenol compounds may be obtained from one or more parts of a plant including for example: leaves; stem; bark; root; bulb; flower; fruit; and seed. The polyphenol compounds disclosed herein may also be synthetic.

The inventor has recognized by optimizing the stepwise administration via optimizing both the effective dose amount and the effective intervals of time between consecutive doses that:
1. Increase in valuable animal products is maximized in said ruminant animal and contributes to economic benefit; and
2. Over-feeding or otherwise over-dosing is prevented which reduces the costs of the feed supplement and contributes to economic benefit; and
3. Over-feeding or otherwise over-dosing is prevented, which prevents the said feed supplement from causing counterproductivity in said ruminant animal and contributes to economic benefit.

The inventor has recognized the unexpected and surprising economic benefits by carefully controlling the stepwise administration of methanogenesis inhibitor feed supplements that comprise certain combinations of organohalogen-rich marine macroalgae, and/or organosulfur-rich plants, and/or polyphenol-rich plants.

The combinations of organohalogen-rich marine macroalgae and/or organosulfur-rich plants, and/or polyphenol-rich plants of when administered to ruminant animals reduce methanogenesis and reduce ruminant methane production. The reduction of methanogenesis occurs by different modes including: reducing methanogenic organisms by limiting their growth or killing them; reducing methanogenic processes, by limiting or stopping enzymes involved in methanogenesis.

The stepwise administration to ruminant animals certain combinations of organohalogen-rich marine macroalgae and organosulfur-rich plants and polyphenol-rich plants of the present invention, have unexpected and surprising enhancement in the reduction of methane emission, and excreted urinary nitrogen, and in the increase of valuable animal products, which is likely due to the synergy between different modes of inhibition of methanogenesis including for example:
1. The organohalogen compounds from Asparagopsis species of marine macroalgae include organobromines, particularly bromoform (CHBr3, tribromomethane), which inhibits the efficiency of the methyltransferase enzyme by reacting with the reduced vitamin B12 cofactor required for the second to last step of methanogenesis and also competitively inhibits methane production by serving as terminal electron acceptors.
2. The organosulfur compounds from Allium species of plants include allicin and diallyl disulfide, which have antimethanogen activity due to the oxidative interaction with important thiol-containing enzymes and by inhibiting the enzyme HMG-CoA reductase
2. The polyphenol compounds from Citrus species of plant include flavonoids neohesperidin and naringin, which have antimethanogen activity.

The inventor has recognized the unexpected and surprising improvements in metabolic efficiency due to the stepwise administration of methanogenesis inhibitor feed supplements or compositions of the present invention may also be due to additional health benefits that include for example: anthelmintic effects that cause a reduction in gastrointestinal parasites; antibacterial effects that cause a reduction of bacterial infections including for example mastitis; and the provision of supplementary trace mineral and vitamins present in combinations of organohalogen-rich marine macroalgae and organosulfur-rich plants and polyphenol-rich plants of the present invention when administered to ruminant animals.

The stepwise administration of organohalogen-rich marine macroalgae and/or organosulfur-rich plants and/or polyphenol-rich plants of the present invention can be administered as feed supplements in certain combinations and certain ratios.

The stepwise administration of combinations of organohalogen-rich marine macroalgae and/or organosulfur-rich plants and polyphenol-rich plants of the present invention can be administered as separate feed supplements or combined into mixed composition feed supplements (e.g., as the composition described herein).

Uses

The stepwise administration of methanogenesis inhibitor animal feed supplements described herein (including all embodiments and combinations of embodiments) may be used to optimize feed supplement administration to reduce methane production and/or emission by animals, reduce nitrogen excretion by animals, increase availability of nutrients to animals and/or increase the valuable nitrogen-rich and carbon-rich animal products by animals.

In certain embodiments, the animal is a ruminant animal. Ruminant animals include, animals selected from the members of the Ruminantia and Tylopoda suborders and include domesticated ruminant animals: for example, cattle (e.g., cows), goats, sheep, buffalo, yaks, deer or antelope.

Specifically, stepwise administration of methanogenesis inhibitor feed supplements or the compositions of the present invention, when administered to ruminant animals, cause reduced ruminant animal methane production, which would otherwise be emitted into the atmosphere by exhaling the gas mainly through the mouth and nostrils, and represents a loss of energy, from 2 to 12% of gross energy intake from feed.

Methane is a greenhouse gas with a global warming potential 28 times that of carbon dioxide. Enteric methane is a by-product of ruminant digestion and is produced by a complex community of microorganisms including ciliate protozoa, bacteria, archaea and anaerobic fungi by the process called methanogenesis. Cattle produce about 7 and 9 times as much methane as sheep and goats, respectively. Enteric methane is produced mainly in the rumen (87%-90%) and, to a lesser extent (13%-10%), in the large intestine.

The stepwise administration of methanogenesis inhibitor feed supplements of the present invention cause the diversion of metabolic energy away from methane generation, and direct it into anabolic growth processes. Thus, the composition or feed supplements cause gains in ruminant animal liveweight determined by: direct weighing of the animal mass; computer tomography (CT) scans to measure empty body mass (total mass less the gut contents); carcass mass, and composition analysis (lean muscle, fat, and major fat distributions; and changes in organs, including the liver).

An example of valuable nitrogen-rich and carbon-rich animal products are tissue-based commodities and includes for example: meat; offal; and leather.

Another example of valuable nitrogen-rich and carbon-rich animal products are secretion-based commodities and products of those commodities and includes for example: milk; whole milk; milk powder; cream; ice-cream; cheese; and yoghurt.

Another example of valuable nitrogen-rich and carbon-rich animal products are fiber-based commodities and includes for example: wool; horn; and antler.

The stepwise administration of methanogenesis inhibitor feed supplements of the present invention cause the unexpected and surprising improvements in metabolic efficiency which likely cause the reduction of excreted urinary nitrogen, which following urination is deposited in urine patches on pastures. When the excess excreted nitrogen in urine patches is greater than required for optimal pasture plant efficiency, excess nitrogen is lost via nitrate (NO3—) leaching, and ammonia (NH3), nitrous oxide (N20) and nitrogen (N2) volatilization. Nitrous oxide is particularly damaging to the atmosphere as a greenhouse gas with a global warming potential 298 times that of carbon dioxide. Nitrogen loss to ground water can cause uncontrolled growth of aquatic biota thereby damaging ecosystems, causing toxic algal blooms, and the eutrophication of water bodies.

Methods of Stepwise Administration

The stepwise administration of the compositions or methanogenesis inhibitor feed supplements described herein may be performed by administering at least one dose of an effective amount of at least one methanogenesis inhibitor and optionally after some effective interval of time administering at least one consecutive dose of an effective amount of at least one methanogenesis inhibitor.

It will be appreciated that consecutive doses of methanogenesis inhibitor feed supplements at intervals of time constitutes stepwise administration. Furthermore, the consecutive dose amounts, and the intervals of time between doses, and the methanogenesis inhibitors may be the same from dose to dose, and from interval of time to interval of time, and from methanogenesis inhibitor to methanogenesis inhibitor, or they may be different dose amounts and/or different intervals of time, and/or different methanogenesis inhibitors.

The animal feed supplements or compositions described herein may be made by combining one or more organohalogen-rich marine macroalgae and one or more organosulfur-rich plant(s) compound(s) and one or more polyphenol-rich plant(s).

The components are combined in suitable amounts to obtain a composition having the desired quantity of each component. Each component may be combined with one or more other components in any order and combination suitable to obtain the desired product. For example, each component may be combined by mixing or blending. For example, the one or more organohalogen compound(s) and one or more organosulfur compound(s) and one or more polyphenol compound(s) may be combined with an animal feed by placing the one or more organohalogen compound(s) and one or more organosulfur compound(s) and one or more polyphenol compound(s) on top of the animal feed (top-dressing).

The methanogenesis inhibitor feed supplement may be prepared to aid in stepwise administration in forms that include: the dry solid form, for example, powder form, and subject to further processing step depending on the types of the formulation for the intended finished products. The methods may further comprise a forming step, wherein the mixture is moulded, pressed, spray dried or otherwise formed into a shape (e.g. bar, ball, pellet, clusters, tablet), preferably with dimensions and/or textures suitable for consumption by an animal of the types described herein. The methods may comprise housing the animal feed or animal methanogenesis inhibitor feed supplement in a specific delivery device such as a syringe. The method may comprise forming composition or animal feed into a bolus tablet that may be intended to stay in the stomach of the animal (e.g. rumen of the ruminant animal).

The methanogenesis inhibitor feed supplement may be stepwise administered for example in dose amounts based on a percentage of the weight of the ruminant animal being selected from the group comprising: 0.1%; 0.2%; 0.3%; 0.4%; 0.5%; 0.6%; 0.7%; 0.8%; 0.9%; 1.0%; 1.1%; 1.2%; 1.3%; 1.4%; 1.5%; 2.0%; 2.5%; 3.0%; 3.5%; 4.0%; 4.5%; 5.0%; and 10%.

The methanogenesis inhibitor feed supplement may be stepwise administered for example in dose amounts based on a percentage of the weight of feed consumed by the ruminant animal selected from the group comprising: 0.1%; 0.2%; 0.3%; 0.4%; 0.5%; 0.6%; 0.7%; 0.8%; 0.9%; 1.0%; 1.1%; 1.2%; 1.3%; 1.4%; 1.5%; 2.0%; 2.5%; 3.0%; 3.5%; 4.0%; 4.5%; 5.0%; and 10%.

The stepwise administration of methanogenesis inhibitor feed supplement may have for example at least one interval of time between consecutive doses selected from the group comprising: 1 minute; 1 hour; 1 day; 2 days; 3 days; 4 days ; 5 days; 6 days; 7 days; 10 days; 2 weeks; 3 weeks 4 weeks; 6 weeks; 2 months; 3 months; 4 months; 6 months; 9 months; and 12 months.

All the uses and methods described herein are considered to be purely non-therapeutic.

The invention will now be described by way of reference only to the following non-limiting examples.

### Example 1—Inhibition of Methane Production by the Methanogenic Archea Methanococcus maripaludis

i) Bromoform and Allicin

The purpose of this experiment was to determine if bromoform and allicin synergise in their ability to inhibit methane production by the methanogenic archaea Methanococcus maripaludis.

For this experiment, bromoform was prepped at 100 mM by adding 8.75 μl bromoform to 991 μl DMSO. This was diluted 10x diluted to generate a 10 mM solution and further diluted to generate 0.12- and 0.156-mM stock solutions. Allicin stock solutions were prepared by adding 48.6 μl allicin to 951.4 μl DMSO to make a 300 mM stock solution and 32.5 μl allicin to 967.5 μl DMSO to make a 200 mM stock solution. The experiment was set up by adding 5 ml of M141 medium (https://www.dsmz.de/microorganisms/medium/pdf/DSMZ_Medium141.pdf) to a screw cap Hungate tube followed by the addition of 5 μl allicin and/or 5 μl bromoform or 10 μl DMSO as follows:
Tube 1: DMSO (10 μl)
Tube 2: Bromoform (5 μl 0.120 mM) (120 nM final)+5 μl DMSO
Tube 3: Bromoform (5 μl 0.156 mM) (156 nM final)+5 μl DMSO
Tube 4: Allicin (5 μl 200 mM) (200 μM final)+5 μl DMSO
Tube 5: Allicin (5 μl 300 mM) (300 μM final)+5 μl DMSO
Tube 6: Bromoform (5 μl 0.120 mM) (120 nM final)+Allicin (5 μl 200 mM) (200 μM final)
Tube 7: Bromoform (5 μl 0.120 mM) (120 nM final)+Allicin (5 μl 300 mM) (300 μM final)
Tube 8: Bromoform (5 μl 0.156 mM) (156 nM final)+Allicin (5 μl 200 mM) (200 μM final)
Tube 9: Bromoform (5 μl 0.156 mM) (156 nM final)+Allicin (5 μl 300 mM) (300 μM final)

After the addition of the test substances, 500 μl of an overnight M. maripaludis culture was added to each reaction tube. Each tube was gassed with 80% H2/20% CO2 to 240 kPa and incubated at 37° C. for 24 h.

After the 24 h incubation the pressure inside the tube was measured using a manometer. Given that 5 moles of H₂/CO₂ are consumed to generate 1 mole of CH₄ the drop in pressure observed was used to calculate the amount of methane by the control and test reactions from which a percent inhibition was calculated.

ii) Bromoform and a powder comprising organosulfur and polyphenols (NXRH214 powder)

The purpose of this experiment was to determine if bromoform and a powder comprising organosulfur and polyphenols synergise in their ability to inhibit methane production by the methanogenic archaea Methanococcus maripaludis.

For this experiment, bromoform was prepped at 100 mM by adding 8.75 μl bromoform to 991 μl DMSO. This was diluted 10× diluted to generate a 10 mM solution and further diluted to generate 0.10- and 0.156-mM stock solutions. The sample was prepared by adding 245 mg NXRH214 powder to 35 ml M141 medium (https://www.dsmz.de/microorganisms/medium/pdf/DSMZ_Medium141.pdf) to generate a 7 mg/ml stock solution. NXRH214 powder is a garlic powder (allicin) and citrus extract (polyphenol flavonoid mix) with a ratio of 93:7, where the flavonoid mix comprises mainly naringin and neohesperidin.

Reaction tubes were set up as follows:
Tube 1: 0 ml NXRH214 (no NXRH214)+5 ml M141+5 μl DMSO
Tube 2: 1 ml NXRH214 (1.4 μg/ml NXRH214)+5 ml M141+5 μl DMSO
Tube 3: 1.5 ml NXRH214 (2.8 μg/ml NXRH214)+3.5 ml M141+5 μl DMSO
Tube 4: 0 ml NXRH214 (no NXRH214)+5 ml M141+5 μl 0.1 mM bromoform (100 nM bromoform)
Tube 5: 1 ml NXRH214 (1.4 μg/ml NXRH214)+5 ml M141+5 μl 0.1 mM bromoform (100 nM bromoform)
Tube 6: 1.5 ml NXRH214 (2.8 μg/ml NXRH214)+3.5 ml M141+5 μl 0.1 mM bromoform (100 nM bromoform)
Tube 7: 0 ml NXRH214 (no NXRH214)+5 ml M141+5 μl 0.156 mM bromoform (156 nM bromoform)
Tube 8: 1 ml NXRH214 (1.4 μg/ml NXRH214)+5 ml M141+5 μl 0.156 mM bromoform (156 nM bromoform)
Tube 9: 1.5 ml NXRH214 (2.8 μg/ml NXRH214)+3.5 ml M141+5 μl 0.156 mM bromoform (156 nM bromoform

After the addition of the test substances, 500 μl of an overnight M. maripaludis culture was added to each reaction tube. Each tube was gassed with 80% H₂/20% CO₂ to 240 kPa and incubated at 37° C. for 24 h.

After the 24 h incubation the pressure inside the tube was measured using a manometer. Given that 5 moles of H₂/CO₂ are consumed to generate 1 mole of CH₄ the drop in pressure observed was used to calculate the amount of methane by the control and test reactions from which a percent inhibition was calculated.

Experimental Results

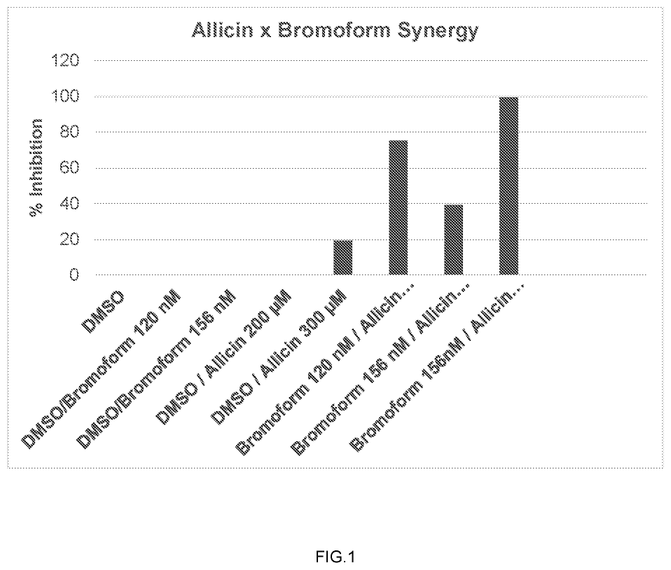

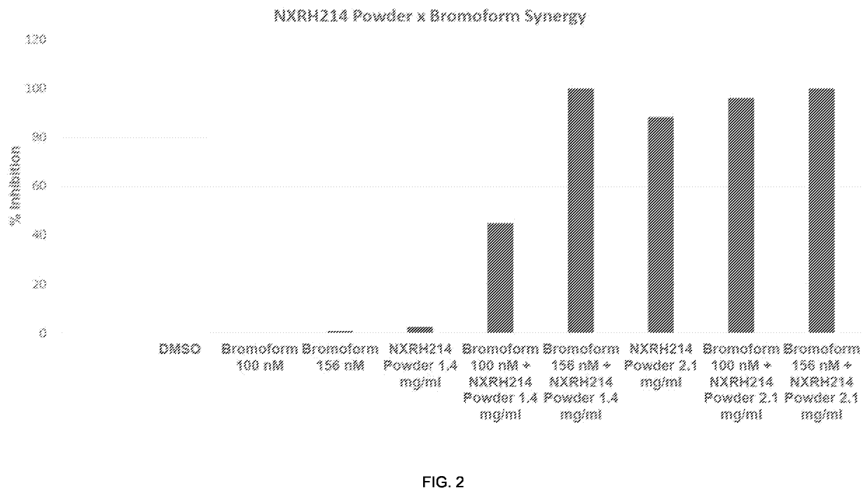

The experimental results for i) Bromoform and Allicin and ii) Bromoform and powder comprising organosulfur and polyphenols (i.e., NXRH214 powder) and are shown in FIGS. 1 and 2 respectively, and in Tables 1 and 2 below.

TABLE 1
Inhibition of Methane with various compositions, including
compositions comprising Bromoform and Allicin.

| | % Inhibition Gas |
|---|---|
| DMSO | 0 |
| DMSO/Bromoform 120 nM | 0 |
| DMSO/Bromoform 156 nM | 0 |
| DMSO/Allicin 200 μM | 0 |
| DMSO/Allicin 300 μM | 19 |
| Bromoform 120 nM/Allicin 300 μM | 75 |
| Bromoform 156 nM/Allicin 200 μM | 39 |
| Bromoform 156 nM/Allicin 300 μM | 99 |

The results show a clear synergy of a composition comprising bromoform and allicin, which is clearly in excess of the % gas inhibition demonstrated by either component alone.

TABLE 2
Inhibition of Methane with various compositions, including
compositions comprising Bromoform and a powder comprising
organosulfur and polyphenols (i.e., NXRH214 powder), which
is a mixture of allicin and bioflavonoid compounds.

| Sample | % Inhibition Gas |
|---|---|
| DMSO | 0 |
| Bromoform 100 nM | 0 |
| Bromoform 156 nM | 0.5 |
| NXRH214 Powder 1.4 mg/ml | 2.2 |
| Bromoform 100 nM + NXRH214 Powder 1.4 mg/ml | 44.8 |
| Bromoform 156 nM + NXRH214 Powder 1.4 mg/ml | 100 |
| NXRH214 Powder 2.1 mg/ml | 88.5 |
| Bromoform 100 nM + NXRH214 Powder 2.1 mg/ml | 96.2 |
| Bromoform 156 nM + NXRH214 Powder 2.1 mg/ml | 100 |

The results also show clear synergy of a composition comprising bromoform and powder comprising organosulfur and polyphenols (i.e., NXRH214 powder), which is clearly in excess of the % gas inhibition demonstrated by either component in the presence of DMSO. NXRH214 powder comprises allicin and polyphenol compounds, more specifically the bioflavonoid compounds naringin and neohesperidin. Thus, a composition comprising bromoform, an organosulfur compound, and a polyphenol can also be used to effectively inhibit methane production.

Conclusion

The data above clearly shows a high % inhibition of methanogen when an organohalogen (i.e., bromoform) is combined with organosulfur (i.e.: allicin) either alone or in combination with polyphenol (i.e.: bioflavonoids from citrus extract).

### Example 2

The feed supplement Mootral™, developed and marketed by Mootral™ SA, Switzerland, and preparations of the marine macroalgae Asparagopsis armata, were combined in various proportions and stepwise administered in various dose amounts and at various intervals of time to sheep on a wholly grass-fed diet. Measurements were made of the emitted methane, blood, body, and feces and compared to control animals that receive no supplement.

The Present Disclosure may also be Described by the Following Paragraphs

A. A method of reducing excreted nitrogen and/or reducing emitted methane and/or increasing nitrogen-rich and carbon rich materials in a ruminant animal comprising the step of administration to said ruminant animal an effective amount of at least one type of methanogenesis inhibitor.

B. The method according to paragraph A, wherein the methanogensis inhibitor is selected from the group comprising: organohalogen compounds; organohalogen-rich marine macroalgae; Organosulfur compounds; organosulfur-rich plants; polyphenol compounds; and polyphenol-rich plants.

C. The method according to claim paragraph B, wherein the organohalogen compound is selected from the group comprising: CH₃Cl; CH₃Br; CH₃I; CH₂Cl₂; CH₂Br₂; CH₂I₂; CHCl₃; CHBr₃; CHI₃; CCl₄; CBr₄; CH₂CIBr; CH₂ClI; CH₂BrI; CHBr₂Cl; CHBrI₂; CHBrClI; CHBr₂I; CHBrCl₂; CH₃CH₂Br; CH₃CH₂I; CH₃CH₂CH₂I; CH₃(CH₂)₃I; CH₃(CH₂)₄Br; CH₃(CH₂)₄I; (CH₃)₂CHI; CH₃CH₂CH(CH₃)I; (CH₃)₂CHCH₂I; BrCH₂CH₂Br; ClCH═CCl₂; and CH₃CH₂CH₂CH₂I.

D. The method according to claim paragraph B, wherein the organohalogen-rich marine macroalgae is selected from the group comprising: Asparagopsis armata; Asparagopsis taxiformis; Dictyota species; Oedogonium species; Ulva species; and Cladophora patentiramea.

E. The method according to claim paragraph B, wherein the organosulfur compound is selected from the group comprising: organosulfur secondary metabolites; allicin (C₆H₁₀S₂O); diallyl sulfide (C₆H₁₀S); diallyl disulfide (C₆H₁₀S₂); and allyl mercaptan (C₃H₆S).

F. The method according to paragraph B, wherein the organosulfur-rich plant is an Allium species selected from the group comprising: Allium sativum; Allium ampeloprasum; and Allium cepa.

G. The method according to paragraph B, wherein the polyphenol compound is selected from the group comprising: flavonoids; bioflavonoids; non-bioflavonoid; The at least one polyphenol compound may, for example, comprise at least one bioflavonoid; anthoxanthins; flavones; flavonols; flavanones; flavanonols; flavans; anthocyanidins; isoflavans; neoflavan anthoxanthins; isoflavones; proanthocyanidins; phenolic acid; hydroxycinnamic acids; coumarins; stilbenoids; anthraquinones; lignans; lignins; tannins; polyphenolic proteins; catechin; rutin; acacetin; genistein; kaempferol; gallocatechin; catechin gallate; epicatechin; epigallocatechin; epicatechin gallate; quercetin; allocatechin; gallocathecin gallate; epicatechin; epigallocatechin; epicatechin gallate; epigallocathecin gallate; kaempferol; quercetin; naringin; neohesperidin; eriocitrin; isonaringin; naringenin; hesperidin; roifolin; diosmin; didymin; hesperetin; poncirin; epicatechin; gallocatechin; epigallocatechin; coumaric acid; cinnamic acid; gallic acid; ellagic acid; protocathechuic acid; chlorogenic acid; caffeic acid; ferullic acid; punicalagin; and punicalin.

H. The method according to paragraph B, wherein the polyphenol-rich plant is selected from the group comprising: Allium species; Brassica species; Camelia species; Capsicum species; Citrus species; Citrus aurantium; Cucumis species; Malus species; Musa species; Phaseolus species; Prunus species; Punica species; Pyrus species; Solanum species; and Vaccinium species.

I. A method of reducing excreted nitrogen and/or reducing emitted methane and/or increasing nitrogen-rich and carbon rich materials in a ruminant animal comprising the stepwise administration to said ruminant animal an effective amount of at least one type of methanogenesis inhibitor.

J. A method according to paragraph I, wherein the stepwise administration has at least one dose of methanogenesis inhibitor that is a percentage of weight of said ruminant animal selected from the group comprising 0.1%; 0.2%; 0.3%; 0.4%; 0.5%; 0.6%; 0.7%; 0.8%; 0.9%; 1.0%; 1.1%; 1.2%; 1.3%; 1.4%; 1.5%; 2.0%; 2.5%; 3.0%; 3.5%; 4.0%; 4.5%; 5.0%; and 10%.

K. A method according to paragraph I, wherein the stepwise administration has at least one dose of methanogenesis inhibitor that is a percentage of weight of feed of said ruminant animal selected from the group comprising: 0.01%, 0.03%, 0.05%, 0.075%, 0.1%; 0.2%; 0.3%; 0.4%; 0.5%; 0.6%; 0.7%; 0.8%; 0.9%; 1.0%; 1.1%; 1.2%; 1.3%; 1.4%; 1.5%; 2.0%; 2.5%; 3.0%; 3.5%; 4.0%; 4.5%; 5.0%; and 10%.

L. A method according to any one of paragraphs I to K, wherein the stepwise administration has at least one interval between consecutive doses selected from the group comprising: 1 minute; 1 hour; 1 day; 2 days; 3 days; 4 days; 5 days; 6 days; 7 days; 10 days; 2 weeks; 3 weeks 4 weeks; 6 weeks; 2 months; 3 months; 4 months; 6 months; 9 months; and 12 months.

1. A composition for reducing methane emission comprising an organohalogen compound and an organosulfur compound.

2. The composition of claim 1, wherein the organohalogen compound is organobromine compound.

3. The composition according to claim 1, wherein the organohalogen is bromoform.

4. The composition according to claim 1, wherein the organosulfur compound is from the Allium species of plants.

5. The composition according to claim 4, wherein the organosulfur compound is allicin (C₆H₁₀S₂O); diallyl sulfide (C₆H₁₀S); diallyl disulfide (C₆H₁₀S₂); and allyl mercaptan (C₃H₆S).

6. The composition according to claim 1, wherein the organosulfur compound is allicin (C₆H₁₀S₂O).

7. The composition according to claim 1, wherein the ratio of organohalogen to organosulfur is from 1:10 to 1:3500.

8. The composition according to claim 1, wherein the ratio of organohalogen to organosulfur is from 1:1000 to 1:2500.

9. The composition according to claim 1, further comprising at least one polyphenol compound.

10. The composition of claim 9, wherein the at least one polyphenol compound comprises at least one bioflavonoid.

11. The composition of claim 9, wherein the at least one polyphenol compound comprises naringin, neohesperidin or a combination thereof.

12. The composition of claim 1, wherein the composition inhibits one or more methanogens.

13. The composition of claim 1, wherein the composition improves metabolic efficiency of an animal.

14. An animal feed comprising the composition of claim 1.

15. The animal feed according to claim 14, wherein the animal feed reduces methane emission and/or inhibits one or more methanogens and/or improves metabolic efficiency of an animal.

16-19. (canceled)

20. The composition of claim 1, wherein: the organohalogen compound is bromoform; the organosulfur compound is allicin (C6H10S2O), diallyl sulfide (C6H10S), diallyl disulfide (C6H10S2), or allyl mercaptan (C3H6S); and further comprising at least one polyphenol.

21. The composition according to claim 20, wherein the organosulfur compound is allicin (C6H10S2O) and the at least one polyphenol is or includes a citrus extract.

22. The composition according to claim 21, embodied as an animal feed for a ruminant animal.

23. A method, comprising:
administering the composition according to claim 1 to an animal to reduce methane emission, inhibit one or more methanogens, and/or improve the metabolic efficiency of an animal.

24. The method according to claim 23, wherein the animal is a ruminant animal selected from a cattle, goat, or sheep.
